(19) United States
(12) Patent Application Publication
(10) Pub. No.: US 2020/0128959 A1
(43) Pub. Date: Apr. 30, 2020

(54) SOFTWARE-GUIDED SMART TECHNOLOGY MOBILE WORKSPACE

(71) Applicant: Mayank Agrawal, San Jose, CA (US)

(72) Inventor: Mayank Agrawal, San Jose, CA (US)

(21) Appl. No.: 16/667,195

(22) Filed: Oct. 29, 2019

Related U.S. Application Data
(60) Provisional application No. 62/752,909, filed on Oct. 30, 2018.

(51) Int. Cl. A47B 83/00; H04L 12/28; G07C 9/00

(52) U.S. Cl. CPC A47B 83/001; G07C 9/00103; G07C 9/00015; H04L 12/282

(57) ABSTRACT

A software-guided smart technology mobile workspace described. The mobile workspace may be designed such that it is appropriate for use as an office space, a conference room, a relaxation area, a sleeping area, a gaming room, an entertainment room, or any other appropriate space. In one embodiment of the system the mobile workspace may include a smart lock, space for up to eight people, seating furniture, a worktable, storage areas, a display monitor, internet connectivity devices, electronically controlled and automated smart lighting, fans, and heating, ventilation, and air conditioning (HVAC). A proprietary software application may be integrated for reservations of the workspace, accessing the workspace, and controlling the workspace during use.

### TECHNICAL FIELD OF THE INVENTION

The present invention relates in general to smart workspaces, and, more specifically, to a software-guided smart technology mobile workspace.

### BACKGROUND OF THE INVENTION

In modern business fewer individuals rely on the classic notion of a dedicated office space from which to work. The advent of coworking spaces has provided such individuals with shared workspace in which to collaborate with others and also reduce their business operating costs. Such coworking spaces, though, tend to be little more than large having few internal walls and a large number of desks. As a result, such spaces lack for privacy and require the individual to deal with distractions and elevated noise levels.

The integration of wireless connectivity and mobile technologies has further reduced even the need for such coworking spaces, allowing an individual to work from any location where they are connected to the internet, such as a coffee shop or internet cafe. Productivity, though, inevitably suffers in less than optimal environments, and an individual is able to get more work done when free from distractions sitting at an office desk than they are sitting in a public or recreational place. Beyond that, even those individuals who conduct business remotely occasionally need a dedicated meeting space to treat with employers or with clients, though such spaces may be difficult to acquire on short notice.

Thus, there is a need in the art for a software-guided smart technology mobile workspace that reduces business operating costs by providing a remote shared work environment while still allowing individuals to work productively in an office setting.

### BRIEF SUMMARY OF THE INVENTION

To minimize the limitations in the prior art, and to minimize other limitations that will be apparent upon reading and understanding the present specification, the present invention describes a software-guided smart technology mobile workspace.

It is an objective of the present invention to provide a software-guided smart technology mobile workspace that may comprise a coworking office space.

It is another objective of the present invention to provide a software-guided smart technology mobile workspace that may comprise a single-person office space.

It is another objective of the present invention to provide a software-guided smart technology mobile workspace that may comprise a multi-person office space.

It is another objective of the present invention to provide a software-guided smart technology mobile workspace that may comprise a meeting space.

It is another objective of the present invention to provide a software-guided smart technology mobile workspace that may comprise a proprietary software.

It is another objective of the present invention to provide a software-guided smart technology mobile workspace that may comprise a mobile software application.

It is another objective of the present invention to provide a software-guided smart technology mobile workspace that may comprise a means for reserving an office space.

It is another objective of the present invention to provide a software-guided smart technology mobile workspace that may comprise a means for unlocking the office space.

It is another objective of the present invention to provide a software-guided smart technology mobile workspace that may comprise smart technology.

It is another objective of the present invention to provide a software-guided smart technology mobile workspace that may comprise a smart lock.

It is another objective of the present invention to provide a software-guided smart technology mobile workspace that may comprise a plurality of technology integrations.

It is another objective of the present invention to provide a software-guided smart technology mobile workspace that may comprise a trailering system.

It is another objective of the present invention to provide a software-guided smart technology mobile workspace that may comprise a drive system.

It is another objective of the present invention to provide a software-guided smart technology mobile workspace that may comprise an autonomous driving system.

It is another objective of the present invention to provide a software-guided smart technology mobile workspace that may comprise an environmental control system.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates an exemplary software-guided smart technology mobile workspace, as contemplated by the present disclosure;

FIG. 2 illustrates an exemplary software-guided smart technology mobile workspace, as contemplated by the present disclosure;

FIG. 3 illustrates an internal view of an exemplary software-guided smart technology mobile workspace, as contemplated by the present disclosure;

FIG. 4 schematically presents an overview of an exemplary software-guided smart technology mobile workspace, as contemplated by the present disclosure; and

FIG. 5 schematically presents a computing system configured to carry out and actualize methods and tasks described herein, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The present invention relates in general to smart workspaces, and, more specifically, to a software-guided smart technology mobile workspace. As contemplated by the present disclosure, the mobile workspace comprises a mobile environment suitable to the needs of a private business office or conference room and integrating a plurality of wireless and smart technologies. The system further comprises a proprietary software from which a user can interact with, reserve, access, and control the mobile workspace. The system may further integrate voice recognition and interaction technologies, as well as autonomous driving technologies.

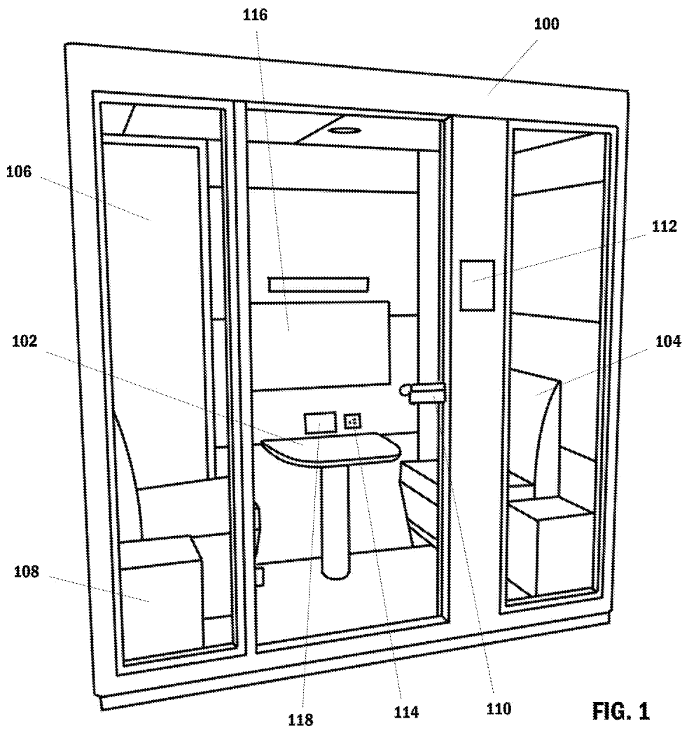

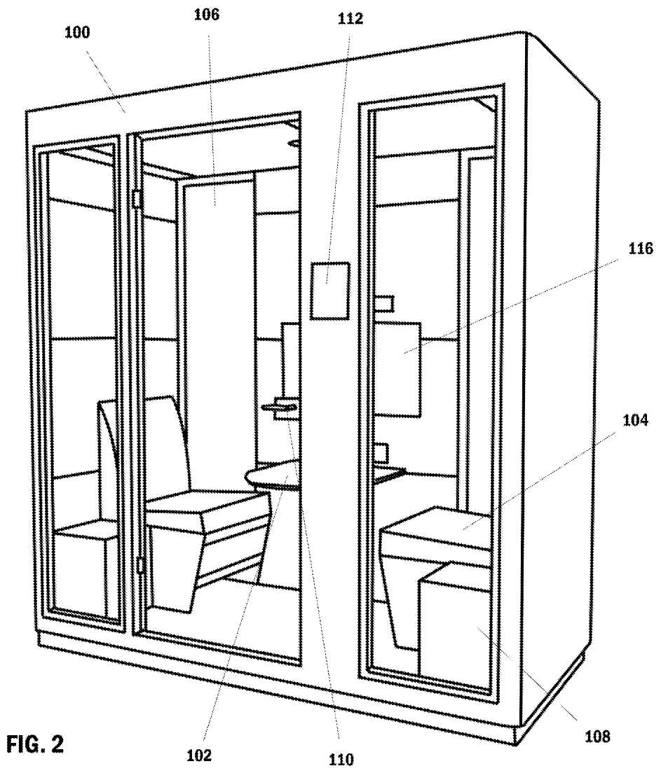

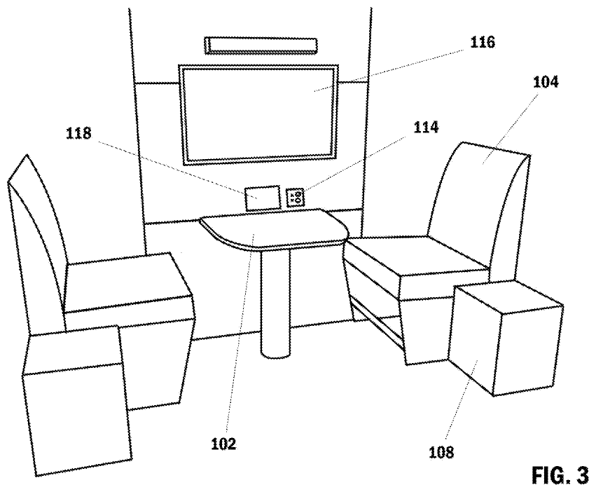

The illustrations of FIGS. 1 through 3 illustrate a software-guided smart technology mobile workspace. The mobile workspace 100 may be designed such that it is appropriate for use as an office space, a conference room, a relaxation area, a sleeping area, a gaming room, an entertainment room, or any other appropriate space. In one embodiment of the system the mobile workspace 100 may include a plurality of worktables 102, a plurality of seating furniture 104, a plurality of windows 106, a plurality of storage areas 108, a smart lock 110, and an access interface 112. Additional features of the software-guided smart technology mobile workspace may include a plurality of plugs 114, a plurality of displays 116, and a control interface 118 to provide additional technology functionality for a user of the workspace. A proprietary software application may be integrated for reservations of the workspace, accessing the workspace, and controlling the workspace during use.

In one embodiment, the smart lock 110 may be an automated device with electronically controlled functions over an internet-enabled cloud application or via near-field communication (NFC) technology authenticated via biometric sensing. In another embodiment, the smart lock 110 may be a magnetic lock unlocked and locked by a pre-assigned passcode. In any embodiment the activation of the smart lock 110 may be controlled by a user's interaction with the access interface 112, such as, for example, by logging in to a user account via the access interface 112 or by scanning a code displayed on a mobile phone via the access interface 112.

In one embodiment the software-guided smart technology mobile workspace may comprise a modular design, wherein the various components of the system may be removed or replaced with minimal effort. By way of example, one or both opposing side walls, or all four walls, may be easily removable so that two or more mobile workspaces 100 may be attached to one another to create a larger single mobile workspace 100. In this way the usable internal space of the mobile workspace 100 may be expandable to accommodate larger groups or needs.

In one embodiment the software-guided smart technology mobile workspace may comprise a palleted floor having retractable wheels and stands. In this way the mobile workspace 100 may be moved on its own wheels by pushing or pulling, or may be lifted by a forklift or similar device, or may be moved and positioned by using a pallet jack.

In one embodiment the software-guided smart technology mobile workspace may comprise a modular roof, wherein the plurality of heating, cooling, and ventilation components may be integrated. Fire, safety, and air conditioning regulations may vary from one jurisdiction to the next, and the inclusion of a modular roof allows the roof panel of the mobile workspace 100 to be swapped, as needed, to satisfy such regulations.

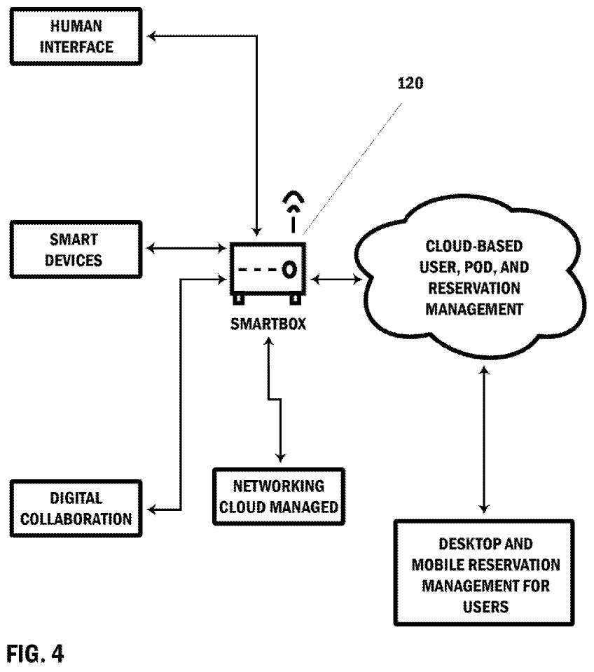

The illustration of FIG. 4 schematically presents an overview of an exemplary software-guided smart technology mobile workspace. The system may comprise a server node, which may be called a “Smartbox” 120, for controlling the various functions of the mobile workspace 100.

The system may further comprise a proprietary software, which may be used to reserve or operate the mobile workspace. In an autonomous driving-equipped embodiment, the software may further set destinations for the mobile workspace and control its movement.

In one embodiment the internet connectivity device may be a wireless access point using wireless fidelity (Wi-Fi) technology with a backhaul provided by a wireline ethernet network. In yet another embodiment, the internet connectivity device may be a wireless cellular network with a localized wireless access point providing a network hotspot. The Wi-Fi technology implemented in any mobile workspace 100 may be managed by the SmartBox 120, and may be used to connect the mobile workspace 100 to a central server and the internet. Wi-Fi access by a user of the mobile workspace 100 may be permitted during their reservation period.

In one embodiment the system may incorporate various software-enabled functions related to the mobile workspace. Such functions may include a means for reserving and operating the mobile workspace 100, unlocking the smart lock 110, connecting wirelessly to the internet, and controlling the various lights and fans in the system. The software may be a proprietary software, and may comprise a downloadable application or a cloud-based web application.

In a preferred embodiment the mobile workspace may comprise an enclosed, modular and mobile structure for people to sit and work, with an electronically lockable door in which people can sit comfortably and work. The system may incorporate a smart locking system designed with an electromagnetic lock, which can be managed remotely or locally.

The system may include a computer and communication devices to manage and operate the various other devices, which may be known as a “SmartBox” 120. The SmartBox 120 may exert control over the Smart Light which operates electronically with the SmartBox 120. The Smart Light operates based on the user made reservation schedule and rules accordingly. The system may also incorporate and Smart Fan which operates electronically with the SmartBox 120. The Smart Fan operates based on the user made reservation schedule and rules accordingly.

In an embodiment wherein the mobile workspace 100 comprises one or more windows or is completely formed from windows, a Smart Glass and Smart Tint system may operate electronically with the SmartBox 120. The Smart Glass operates based on the user made reservation schedule and rules accordingly

A Smart Display and Smart Monitor may operate electronically with the SmartBox 120. The Smart Monitor is remotely managed for content and also used as a projection display for local devices in the mobile workspace. The system may incorporate multiple wireless sensors to monitor operating conditions of the smart mobile workspace managed by the SmartBox 120. The system may include a wireless Wi-Fi access point providing internet services in the smart mobile workspace controlled and operated based on the user made reservation schedule and rules.

A touchscreen display, which may be called an access interface 112, may be mounted outside the mobile workspace and used to reserve and operate the mobile workspace. The system may also include a touchscreen display inside the mobile workspace, which may be called a control interface 118, to be used to manage the reservation and operate the mobile workspace 100. The system may also include a voice assistant-enabled smart speaker and interaction system.

In another embodiment the mobile workspace 100 may be reserved via any appropriate software application operating on a mobile phone, a computing device, or the touchscreen display mounted on the mobile workspace. The software may also manage and operate the mobile workspace 100 using mobile and touchscreen device software applications and may lock and unlock the mobile workspace 100.

The mobile workspace 100 may interact wirelessly with the software application and the central databases for data transfer and recording, and to manage reservations and travel locations. The mobile workspace 100 may also allow a user to interact wirelessly with the space itself to mirror computing devices and displays onto onboard monitors and projectors. The user may also engage the software to develop automated rules for controlling the mobile workspace, the environment within the workspace, or the work occurring within the workspace.

The mobile workspace 100 may further comprise a plurality of cameras used for image processing. The processed images may be analyzed using machine learning to determine if the mobile workspace 100 is occupied by persons at unexpected times, is occupied by an unexpected number of persons, is left dirty or requires cleanup or maintenance, or if person using the mobile workspace 100 left behind personal items. The system may detect such anomalies and react, as appropriate, by notifying a central database, notifying a cleaning or maintenance crew, or notifying the previous user of the mobile workspace 100.

In a self-driving embodiment, the mobile workspace may comprise any combination of autonomous components and automobile components, though most relevant to the invention are its powertrain, suspension, and braking subsystems. The autonomous system controls these various subsystems via actuation means that may accelerate, turn, and brake the vehicle under its direction. To determine the appropriateness of such controls, the autonomous system further comprises a plurality of sensors that allow for detection of the surrounding area and the present state of the mobile workspace. In one embodiment the autonomous system further comprises a database of route maps and known traffic rules and behaviors acceptable to its operating environment.

In one embodiment a user may reserve time in the mobile workspace 100 using a mobile application or web application or tablet device, hereinafter referred to as an application. The application communicates via https to a server in the cloud to present a user-interface showing the availability of a mobile workspace 100. The user may then use one of the applications to reserve a mobile workspace for a given amount of time, and pay for the use with any appropriate payment method, such as Stripe, Square, PayPal, Google Pay, Apple Pay.

The server software, hereinafter referred to as the backend, receiving the request from the applications, may be implemented as a Python Django Server backend running on a cloud virtual machine such as one running on Google GCP, Microsoft Azure, Amazon AWS or Salesforce/Heroku.

The backend stores and retrieves customer and mobile workspace 100 reservation information in a database such as Postgre SQL database. The mobile workspace itself contains a small hardware computing device with network connectivity such as an edge IOT gateway. The computing device communicates with the devices using wired and wireless connections with digital devices and uses controllers to change the state of analog devices.

The computing device contains three systems, the first to communicate with the backend, which can get information about the current reservation and can prepare the mobile workspace 100 for the current user. The second, schedule system, contains the list of jobs and how the mobile workspace 100 should behave for the selected hour, for example blinking the light or unlocking the doors. The third system is used to control the devices from inside of the mobile workspace 100 by the user. Each system can communicate between each other using a Redis server or similar other servers.

The computing device polls regularly, using https or WebSockets, to look for mobile workspace reservations and unlocks the door to the mobile workspace and turns on other devices such as the lights, the fans, and the sockets on demand or when a user enters the correct reservation code in a tablet device at the scheduled time, or when the user hits the unlock button in the application.

Hardware may also play a recorded voice upon entry and to tell the user to exit as well as provide notifications by playing sounds or turning off or dimming the lights when a mobile workspace 100 reservation is ending or is near to its end.

After all individuals have left the mobile workspace 100 at the end of the mobile workspace 100 reservation, the hardware device can lock the doors by operating a relay that closes a magnetic lock on the door. The hardware device in the mobile workspace 100 then communicates with the reservation server running in the cloud to register the mobile workspace 100 reservation as ended.

For billing, at the end of the month, the list of mobile workspace 100 reservations may be queried and customers billed appropriately. Alternatively, mobile workspace 100 reservations can be paid for immediately upon completion or immediately upon reservation. In one embodiment, a mobile workspace 100 user may swipe their credit card on a credit card reader on the outside of the mobile workspace to reserve time in the mobile workspace.

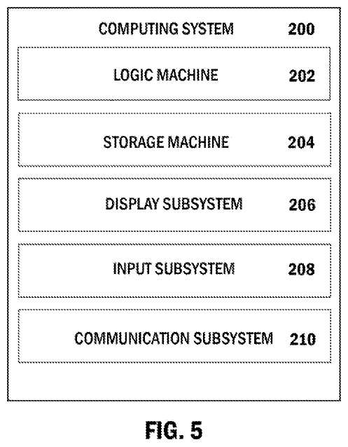

The illustration of FIG. 5 schematically presents a computing system that may represent an embodiment of the present invention. In some embodiments the method is executed on a computing system such as computing system 200. For example, storage machine 204 may hold instructions executable by logic machine 202 to provide the method to users.

Display subsystem 206 may display the various elements of the method to participants. For example, display subsystem 206, storage machine 204, and logic machine 202 may be integrated such that the method may be executed while being displayed on a display screen. The input subsystem 208 may receive user input from participants to indicate the various choices or user inputs described above.

The described method may be executed, provided, or implemented to a user on one or more computing devices via a computer-program product such as via an application programming interface (API). Computing system 200 may be any appropriate computing device such as a personal computer, tablet computing device, gaming device or console, mobile computing device, etc. Computing system 200 includes a logic machine 202 and a storage machine 204. Computing system 200 may include a display subsystem 206, input subsystem 208, and communication subsystem 210.

Logic machine 202 may execute machine-readable instructions via one or more physical devices. For example, the logic machine 202 may be configured to execute instructions to perform tasks for a computer program. The logic machine may include one or more processors to execute machine-readable instructions.

Storage machine 204 includes one or more physical devices configured to hold or store instructions executable by the logic machine to implement the method. When such methods and processes are implemented, the state of storage machine 204 may be changed to hold different data. For example, storage machine 204 may include memory devices such as various hard disk drives or CD or DVD devices.

Display subsystem 206 may visually present data stored on storage machine 204. For example, display subsystem 206 may visually present data to form a graphical user interface (GUI). Input subsystem 208 may be configured to connect and receive input from devices such as a mouse, keyboard, or gaming controller. Communication subsystem 210 may be configured to enable system 200 to communicate with other computing devices. Communication subsystem 210 may include wired and/or wireless communication devices to facilitate networked communication.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A software-guided smart technology mobile workspace, comprising:
a workspace;
a smartbox;
a smart lock; and
an access interface;
wherein said workspace comprises a room not permanently attached to a foundation;
wherein said smartbox comprises a server node attached to said workspace;
wherein said smartbox controls a plurality of functions of said workspace;
wherein said smart lock comprises a lock attached to a door of said workspace;
wherein said access interface is attached on an outer surface of said workspace; and
wherein said smart lock is locked and unlocked via said access interface.

2. The invention of claim 1, further comprising:
a plurality of worktables;
a plurality of seating furniture;
a plurality of windows; and
a plurality of storage areas;
wherein said plurality of worktables, said plurality of seating furniture, and said plurality of storage areas are installed within said workspace; and
wherein said plurality of windows are installed within a plurality of walls of said workspace.

3. The invention of claim 2, further comprising:
a control interface; and
a proprietary software;
wherein said control interface is installed within said workspace;
wherein said proprietary software is accessed via said control interface;
wherein said proprietary software sends a plurality of instructions to said smartbox; and
wherein said proprietary software receives a plurality of data from said smartbox.

4. The invention of claim 3, further comprising:
a plurality of displays;
wherein said plurality of displays are controlled by said proprietary software; and
wherein said plurality of displays display digital media selected by a user.

5. The invention of claim 4, further comprising:
a plurality of plugs;
wherein said plurality of plugs are controlled by said proprietary software; and
wherein said plurality of plugs receive a plurality of hardware connectors of said user.

6. The invention of claim 5, further comprising:
a plurality of speakers;
wherein said plurality of speakers are controlled by said proprietary software; and
wherein said plurality of speakers output audio within said workspace.

7. The invention of claim 6, further comprising:
a plurality of lights;
wherein said plurality of lights are controlled by said proprietary software; and
wherein said plurality of lights output light within said workspace.

8. The invention of claim 7, further comprising:
an air conditioning system;
wherein said air conditioning system is controlled by said proprietary software; and
wherein said air conditioning system modifies an environment within said workspace.

9. The invention of claim 8, further comprising:
a wireless connectivity;
wherein said wireless connectivity is installed within said workspace;
wherein said wireless connectivity allows said smartbox and said proprietary software to connect wirelessly to a central server.

10. The invention of claim 9, further comprising:
a mobile software application;
wherein said wireless connectivity allows said smartbox and said proprietary software to connect wirelessly to said mobile software application installed on a mobile device of said user.

11. The invention of claim 10, further comprising:
a plurality of cameras;
wherein said plurality of cameras are controlled by said proprietary software; and
wherein said plurality of cameras monitor conditions within said workspace.

12. The invention of claim 11,
wherein said workspace comprises a modular construction.

13. The invention of claim 12, further comprising:
a plurality of wheels;
wherein said plurality of wheels are attached to said workspace;
wherein said plurality of wheels allow said workspace to be rolled; and
wherein said plurality of wheels are reversibly lockable.

14. The invention of claim 13,
wherein said smart lock is an electromagnetic lock.

15. The invention of claim 14,
wherein said user uses said mobile software application to reserve, lock, unlock, and pay for said workspace.

16. The invention of claim 15,
wherein said plurality of windows are self-tinting.

17. The invention of claim 16, further comprising:
a credit card reader;
wherein said credit card reader is used to receive payments from said user.

18. The invention of claim 17, further comprising:
a self-driving technology.
